(19) United States
(12) Patent Application Publication
(10) Pub. No.: US 2008/0263034 A1
(43) Pub. Date: Oct. 23, 2008

(54) METHOD AND APPARATUS FOR QUERYING BETWEEN SOFTWARE OBJECTS

(76) Inventors: SATYADEEP DEY, Kolkata (IN); Himanshu Kacker, Bangalore (IN); Steffen Tatzel, Nussloch (DE); Joerg Willi Walzenbach, Ueberherm (DE); Wolfgang Gentes, Zweibruecken (DE)

Correspondence Address: SAP AG, 3410 HILLVIEW AVENUE, PALO ALTO, CA, 94304, US

(21) Appl. No.: 11/737,747

(22) Filed: Apr. 19, 2007

(51) Int. Cl. G06F 17/30

(52) U.S. Cl. 707/6; 707/E17.017

(57) ABSTRACT

A query fetches data from a source software object into a target software object using services and data types of the source software object. The target software object can then provide additional services which are not provided by the source software object.

### FIELD OF THE INVENTION

The invention relates to the field of enterprise software, in particular to a service oriented architecture (SOA).

### BACKGROUND OF THE INVENTION

A software object typically has a plurality of nodes, one of which is a root node. The root node typically has subordinate elements (also called attributes) and/or nodes referred to as child nodes. The child nodes further may have one or more attributes and/or nodes. For example, the software object “Sales Order” may have the software object root node “SalesOrder” which typically has nodes such as sales order header. The sales order header node typically has attributes like “order number”, “order date”. A query is performed on a root node to obtain data for the root node. The root node may be associated with another node from the same software object or a different software object. This association enables fetching data from one node into the other. An association represents a relationship between two entities. For example, in a sales scenario, the sales order may not exist without a customer assigned to it. This means that a sales order is associated with a customer. Hence, a sales order software object has an association with customer software object. As part of this association, the sales order software object may have data of the customer software object, for example, customer identification number, using which a customer software object can be fetched from the sales order software object. Thus, the association between sales order software object and customer software object helps fetching data from one software object into the other.

However, the above querying technique for fetching data from a source software object into a target software object using an association is limited, as described below.

Consider an association between the source software object and the target software object. When a new record of the target software object is created, there may be no link to the records of the source software object even though because of the association, a foreign key relation may exist between a field of the target software object and a field of the source software object. Since the target software object record is newly created, there may be no corresponding record in source software object and hence no data can be fetched from source software object. However, the data can be fetched from the source software object but that involves more processing steps.

### SUMMARY OF THE INVENTION

What is described is a system and method of querying data from a source software object into a target software object using services and data types of the source software object. The data from the source software object is fetched into a child node of the target software object.

A target software object searching for node identifications (IDs) of a source software object in a source software object which match a search criteria and retrieving the node IDs of the source software object responsive to the search. The retrieved node IDs of the source software object are mapped to a root node identification (ID) of the target software object. Finally, the source software object is associated with the target software object by associating the mapped node IDs of the source software object with the root node ID of the target software object.

### BRIEF DESCRIPTION OF THE DRAWINGS

FIG. 1 illustrates a service oriented architecture (SOA) in accordance with an embodiment of the invention.

FIG. 2 illustrates the structure of the target and source software objects and the association between the same according to an embodiment of the invention.

FIG. 3 illustrates an association between target and source software objects according to an embodiment of the invention.

FIG. 4 illustrates the process of fetching the source software object data into the target software object by associating the target software object root node identification (ID) with the source software object node IDs according to an embodiment of the invention.

FIG. 5 illustrates an embodiment of the invention.

FIG. 6 is a flowchart that illustrates certain aspects of a method for fetching the source software object data into target software object according to an embodiment of the invention.

FIG. 7 illustrates the various hardware components of the system in which an embodiment of the invention may be used.

### DETAILED DESCRIPTION

A target software object searching for node identifications (IDs) of a source software object in a source software object which match a search criteria and retrieving the node IDs of the source software object responsive to the search. The retrieved node IDs of the source software object are mapped to a root node identification (ID) of the target software object. Finally, the source software object is associated with the target software object by associating the mapped node IDs of the source software object with the root node ID of the target software object.

Service oriented architecture (SOA) supports the design, development, identification and consumption of standardized software services across an enterprise, thereby improving reusability and flexibility of software components. Enterprise service architecture (ESA) is a blueprint for SOA that more effectively addresses business software needs and is rapidly deployable.

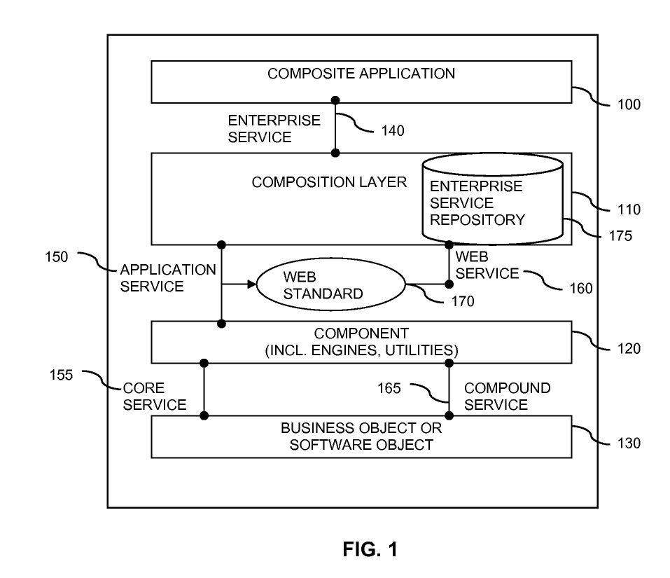

FIG. 1 illustrates the SOA. Composite application 100 resides on top of component 120, and makes use of data and functions that are provided as services that include application service 150 and web service 160 by the underlying component 120. The composite application 100 may add business logic and provide user interfaces in support of a business application.

A composition layer 110 allows a model based composition and orchestration of services to enable or enhance business processes. The composition layer 110 typically enables the development, deployment and administration of enterprise service 140. The composition layer 110 typically provides tools for creating and managing enterprise service 140 and also typically supports the design, implementation and execution of applications that use enterprise services 140, like composite applications in layer 100. The composition layer 110 typically includes an Enterprise Service Repository (ESR) 175 which is a central repository where enterprise services 140 and software objects 130 are modeled and their corresponding metadata stored. The enterprise service 140 is typically a web service 160 that has an enterprise level business meaning. Enterprise services 140 are typically an aggregation of application services 150 or web services 160 of lower or smaller business functionality combined with business logic to support a step of a business process. The enterprise services 140 are typically hosted in an enterprise server. Web services 160 represent a self-contained, self-describing piece of application functionality that can be accessed by other applications. An application service 150 represents services exposed from an application component or component 120 and allows access to a lower or smaller level of functionality of enterprise applications. An application service 150 can either be proprietary or could be implemented in web standard 170 such as extensible markup language (XML) to become a web service 160.

Component 120 is typically a modular, re-usable piece of application software. SOA applications are constructed from the component 120 and composite application 100 according to the ESA. The components 120 are made up of various entities that include engines, utilities and software objects 130. The software objects 130 typically provide a set of functionalities or services. For example, a customer or business partner software object may provide services such as obtaining the name, address, and contact details of a customer.

Consider two software objects, a target software object which typically fetches data from another software object, referred to herein as the source software object. According to one embodiment of the invention, the source software object typically has an association with the target software object.

The software objects communicate with each other according to ESA. Software objects communicate using at least the interfaces described in table 1 below. These interfaces are implemented by the software objects.

TABLE 1

| Interface | Method | Called when | Function |
|---|---|---|---|
| Query Interface | Query | When Query is | Searches for |
| Pattern | | executed | software object |
| | | | identities - i.e. it |
| | | | returns a set of node |
| | | | IDs (also called |
| | | | primary keys) of |
| | | | software object node |
| | | | elements |
| Access Interface | Retrieve | When Query is | Fetches the software |
| Pattern | | executed | object node data that |
| | | | matches a given set |
| | | | of software object |
| | | | node IDs |
| | RetrieveByAssociation | Navigation to an | Determines the |
| | | association, that | relationship between |
| | | is, when the data | two software object |
| | | of the associated | nodes. That is, for a |
| | | software object is | given target software |
| | | accessed | object node ID, the |
| | | | resulting list of node IDs |
| | | | of the source |
| | | | software object is |
| | | | ascertained |

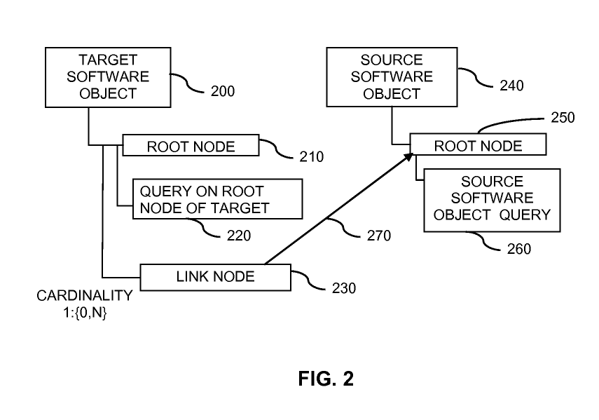

FIG. 2 illustrates a simplified block diagram of the structure of a software object and an association 270 between a target software object 200 and a source software object 240 in one embodiment of an invention. The target software object 200 typically has a root node 210, a query 220 on the root node 210, and a child node, also referred to as link node, 230, having an association 270 with a root node 250 of the source software object 240. The association between the source software object 240 and the target software object 200 is defined during the development of the software objects. The root node 250 of the source software object 240 typically has a query 260 which when executed typically retrieves data for the root node 250. The query 220 on the root node of the target software object typically has the same Global Data Type (GDT) as the source software object query 260. The link node 230 typically has the same GDT as source software object root node 250 to ensure any structural changes in the source software object are automatically reflected in the target software object. The GDT typically is a standardized set of data types that are used to define the nodes, attributes of a software object.

When the query 220 on the root node of the target software object is executed, a single record at the root node 210 is created and the node identifications (IDs) of the records of the source software object 240 are typically fetched into the link node 230 of the target software object by executing a query on the source software object root node 250. These node identifications may also be referred to as primary keys because they are used as indexes, or keys, to the records in the source software object. Since the node IDs of the source software object records are typically available in the link node 230 of the target software object, it is typically possible to fetch other details of the source software object records by traversing through the association between the link node 230 of the target software object and the root node 250 of the source software object.

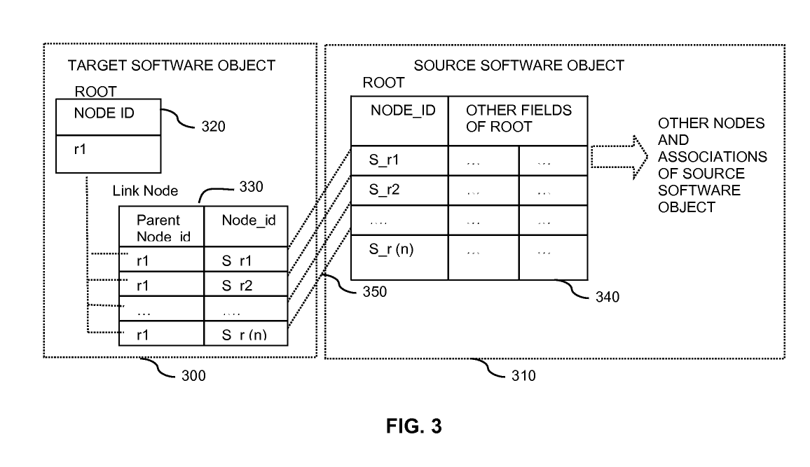

FIG. 3 shows a detailed block diagram of the link node 330 in target software object 300 having a one-to-one (1:1) association 350 with the root node 340 of the source software object 310. Since the link node 330 has a 1:1 association 350 with the root node 340 of the source software object, it is typically possible to access data belonging to other nodes and associations of the source software object as the other nodes of the source software object are under the root node 340 and the root node 340 provides access to these nodes and their associations.

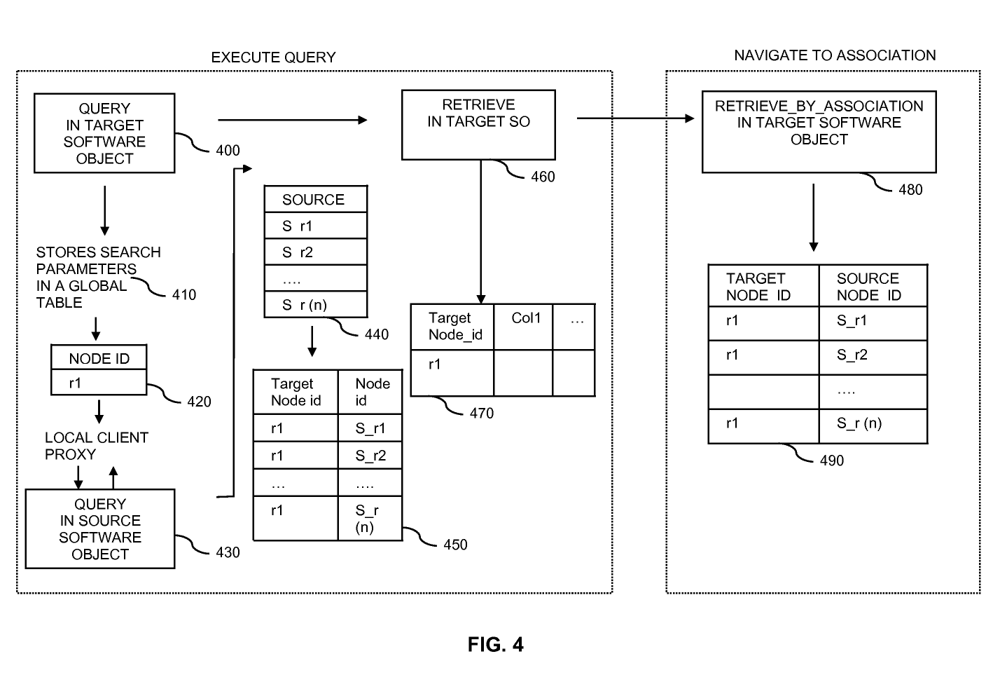

FIG. 4 illustrates in detail the process of the target software object fetching data from the source software object. The process involves executing a query on the target software object as indicated in 400, executing a retrieve method on the target software object as indicated in 460 and executing a retrieve by association method on the target software object as indicated in 480.

The target software object receives a set of search parameters for which to fetch the records from the source software object. The query 400 is executed with this set of search parameters as an input on the root node of target software object. The search parameters are typically stored in a temporary data store, referred to herein as a global table 410, and a root node ID 420 of the target software object is created. The target software object then executes a query 430 on the source software object typically via a local client proxy, passing the search parameters stored in the global table 410 as input parameters. The query 430 searches for a list of node IDs matching the search criteria and retrieves the list of node IDs 440 from the source software object responsive to the search. The list of node IDs 440 is then mapped to the root node ID 420 of the target software object and stored in a global table 450, a temporary data store.

After a query is executed on the target software object, typically a retrieve method is executed to retrieve the data based on the search performed in the query. The retrieve method receives the root node ID 420 as input, and in one embodiment of the invention, the retrieve method returns a null record 470 filled with the received root node ID 420. The retrieve method typically receives only one node ID as input, as the query on the root node of the software object typically returns only one record.

Typically, the retrieve_by_association method is executed when the child node is accessed from a parent node. The retrieve_by_association method typically returns a list of source node IDs and target node IDs by taking the source node ID as input. The method 480 is executed when the link node 490 of the target software object, is accessed from the root node 420. The method 480 fetches the list of source software object node IDs 440 by taking the root node ID 420 as input. The method 480 retrieves the corresponding list of source software object node IDs 440 from the global table 450, since the global table 450 has the mapping between the target software object root node ID 420 and source software object node IDs 440. The retrieved list 440 is fetched into the link node 490 of the target software object and is associated with the root node ID 420 of the target software object as depicted in 490.

With the association 490, any data from the source software object can be fetched by the target software object since the link node 490 of the target software object typically has the node IDs of the source software object. In this way the target software object can provide additional functionality or services that are not already provided by source software object.

Consider an example business scenario of direct mailing, in which a personalized electronic mail (e-mail) is sent to a list of business partners or customers. The software objects in the example are direct mail (DM), business partner (BP) and direct mail template (DMT). The DM software object is the target software object which sends e-mail by selecting a business partner and an e-mail template from the BP software object and the DMT software object, respectively. The BP software object is a source software object from which the BP data such as e-mail ID is typically fetched. The DMT software object is another source software object from which an e-mail template is selected. The DM software object has an association with the software objects BP and DMT. The structure of the DM software object and BP software object is similar to the target software object 300 and the source software object 310 in FIG. 3 respectively. Also, the association between DM software object and BP software object is similar to the association 350 between the target software object 300 and the source software object 310 in FIG. 3.

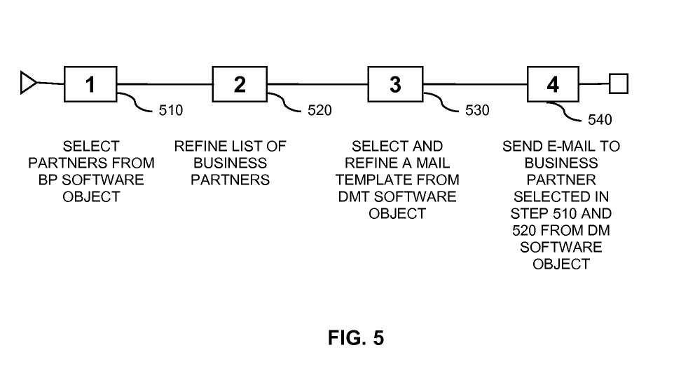

FIG. 5 illustrates the above direct mailing scenario. The process typically begins with selecting the business partner 510 from the list of business partners from BP software object, which is the source software object. At 520, the selected list of business partners is then refined based on a search criterion and fetched into the DM software object, which is the target software object. After selecting the business partners, the same process of selection and refinement is repeated with DMT software object for the personalized e-mail templates for the business partners at 530. At 540, the DM software object typically sends out the personalized e-mail to the selected list of business partners. The DM software object typically is providing an additional functionality of sending out an e-mail to the business partners, a functionality that is not provided by the BP software object.

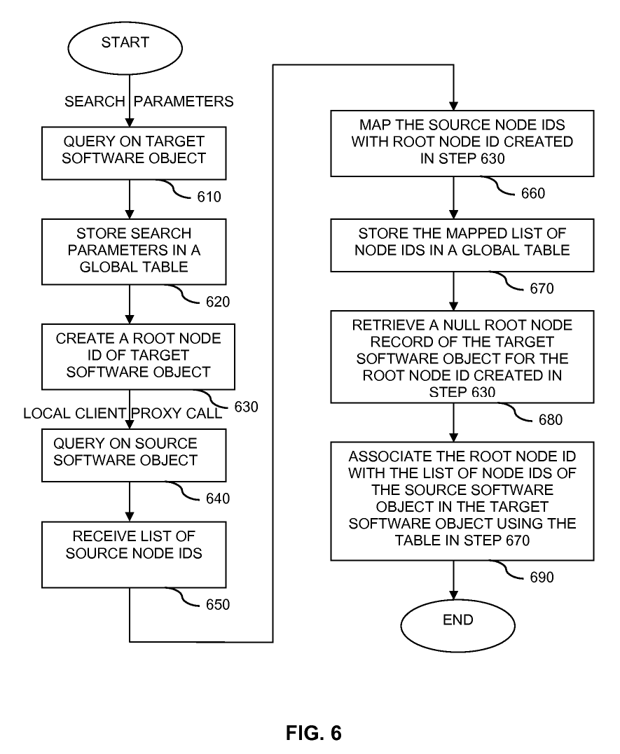

FIG. 6 is a flowchart that illustrates certain aspects of a method for fetching the source software object data into target software object according to an embodiment of the invention. Applying this flowchart to the direct mailing scenario, as described in FIG. 5, the process is as follows. At 610, a query is performed on the target software object, that is, the DM software object in the scenario explained above. A set of search parameters are also provided as input to the query. At 620, the search parameters are stored in a global table 410 (as shown in FIG. 4). At 630, the root node ID 420 of the DM software object is created. At 640, the DM software object executes a query on the source software object, that is, the BP software object in the scenario. The query on BP software object is made via a local client proxy call. The search parameters stored in the global table at 620 are provided as input to the query. At 650, the query returns the list of node IDs 440 of the business partner records from the BP software object. At 660, the above list of node IDs of the business partner records is mapped with the DM software object root node ID created at 630.

At 670, the mapped list of the node IDs is stored in a global table 450. At 680, the retrieve method of the DM software object query returns a null record of the root node for the root node ID created at 630. At 690, the root node ID created at 630 is associated with the list of mapped node IDs stored in global table created at 670. The DM software object now has a list of business partner node IDs in its link node 490. Since the link node 490 of the DM software object has a 1:1 association with the root node of the BP software object, additional details of the business partner like e-mail ID, etc., can be fetched. Similarly, the DM software object can also fetch the personalized e-mail template from the DMT software object for a particular business partner selected from the BP software object. Finally, the DM software object sends the personalized e-mail to the business partner selected from the BP software object.

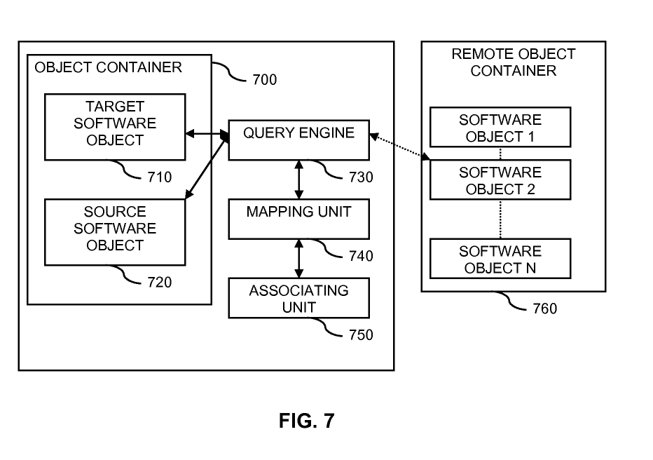

FIG. 7 depicts various blocks of the system for performing a query between software objects. The system contains a query engine 730 in the processor of the system that typically queries the software objects including the target software object 710 and source software object 720 contained in one or more object containers 700 in the memory of the system. The software objects may also be contained in a remote object container 760. The system includes a mapping unit 740 that provides a means for mapping the root node ID of the target software object with the node IDs of the source software object and an associating unit 750 that provide a means for associating the mapped node IDs the source software object with the root node ID of the target software object.

What is claimed is:

1. A method, comprising:
creating a root node identification (ID) of a target software object;
searching for node identifications (IDs) of a source software object in a source software object which match a search criteria;
retrieving the node IDs of the source software object responsive to the search;
mapping the retrieved node IDs of the source software object to the root node ID of the target software object; and
associating the mapped node IDs of the source software object with the root node ID of the target software object.

2. The method in claim 1, wherein the created root node ID is initially associated with a null record.

3. The method in claim 1, further comprising receiving the search criteria at the target software object.

4. The method in claim 1, wherein creating the root node ID comprises creating the root node ID in a temporary data store.

5. The method in claim 1, wherein searching for the node IDs of the source software object in the source software object comprises the target software object querying the source software object for the node IDs of the source software object using the search criteria.

6. The method in claim 5, wherein the target software object querying the source software object comprises the target software object querying the source software object via a local client proxy call.

7. The method in claim 5, wherein the target software object queries the source software object by reusing a source software object query.

8. The method in claim 7, wherein each query of the source software object that the target software object reuses, the target software object query's global data type is same as the source software object query.

9. The method in claim 1, wherein mapping the retrieved node IDs comprises mapping the retrieved node IDs of the source software object to the root node ID of the target software object in a second temporary data store.

10. The method in claim 1, wherein associating the mapped node IDs comprises associating the mapped node IDs of the source software object with the root node ID of the target software object in the target software object.

11. An article of manufacture, comprising:
a machine readable medium having instructions that when executed by a machine cause the machine to execute a method, comprising:
creating a root node ID of a target software object;
searching for node IDs of a source software object in a source software object which match a search criteria;
retrieving the node IDs of the source software object responsive to the search;
mapping the retrieved node IDs of the source software object to the root node ID of the target software object; and
associating the mapped node IDs of the source software object with the root node IDs of the target software object.

12. The article of manufacture in claim 11, wherein the created root node ID is initially associated with a null record.

13. The article of manufacture in claim 11, wherein the search criteria comprises receiving the search criteria at the target software object.

14. The article of manufacture in claim 11, wherein creating the root node ID comprises creating the root node ID in a temporary data store.

15. The article of manufacture in claim 11, wherein searching for the node IDs of the source software object in the source software object comprises the target software object querying the source software object for the node IDs in the source software object using the received search criteria.

16. The article of manufacture in claim 15, wherein the target software object queries the source software object via local client proxy call.

17. The article of manufacture in claim 15, wherein the target software object queries the source software object by reusing the source software object query.

18. The article of manufacture in claim 15, each query of the source software object that the target software object reuses, the target software object query's global data type is same as the source software object query.

19. The article of manufacture in claim 11, wherein mapping the retrieved node IDs comprises mapping the retrieved node IDs of the source software object to the root node ID of the target software object in a second temporary data store.

20. The article of manufacture in claim 11, wherein associating the mapped node IDs comprises associating the mapped node IDs of the source software object with the root node ID of the target software object in the target software object.

21. A system, comprising:
a processor having memory;
one or more object containers in the memory containing software objects including a target software object and a source software object;
a querying engine in the processor that the target software object uses to query the source software object and retrieve the list of node identifications (IDs) of the source software object;
means for mapping a root node identification (ID) of the target software object with the retrieved list of node IDs of the source software object; and
means for associating the mapped node IDs of the source software object with the root node ID of the target software object.

22. The system of claim 21, further comprising a means for the querying engine to communicate with software objects contained in a remote object container.
